(19) United States
(12) Patent Application Publication
(10) Pub. No.: US 2026/0321813 A1
(43) Pub. Date: Oct. 15, 2026

(54) BIODEGRADABLE BATTERIES OPERATIONAL IN THE AIR AND SOIL

(71) Applicant: THE TRUSTEES OF THE UNIVERSITY OF PENNSYLVANIA, Philadelphia, PA (US)

(72) Inventors: Jingwen ZHANG, Philadelphia, PA (US); Mark G. ALLEN, Philadelphia, PA (US)

(21) Appl. No.: 19/485,689

(22) PCT Filed: May 22, 2024
(86) PCT No.: PCT/US2024/030482

§ 371 Date: Nov. 19, 2025

Related U.S. Application Data
(60) Provisional application No. 63/503,536, filed on May 22, 2023.

(51) Int. Cl. H01M 50/121; H01M 4/96; H01M 12/06

(52) U.S. Cl. CPC H01M 50/121; H01M 4/96; H01M 12/06

(57) ABSTRACT

Disclosed is a power cell that includes a metallic anode; an air cathode; an electrolyte, the electrolyte placing the metallic anode into electronic communication with the air cathode; and an enclosure, the enclosure encapsulating therein the metallic anode, the air cathode, and the electrolyte. The enclosure can include an air path and minimize the exposure of the battery to the external environment while allow the sufficient air flux for battery operation, and the enclosure can comprise a biodegradable material, such as a wax. Also disclosed is a method, comprising implanting a power cell according to the present disclosure into a soil environment. Also described is a method, comprising assembling a power cell according to the present disclosure. Further provided is a method, comprising powering a device using a power cell according to the present disclosure.

### CROSS-REFERENCE TO RELATED APPLICATIONS

The present application claims priority to and the benefit of U.S. patent application no. 63/503,536, “Biodegradable Batteries Operational in the Air and Soil” (filed May 22, 2023). All foregoing applications are incorporated herein by reference in their entireties for any and all purposes.

### GOVERNMENT RIGHTS

This invention was made with government support under 1941529 and 2025608 awarded by the National Science Foundation. The government has certain rights in the invention.

### TECHNICAL FIELD

The present disclosure relates to the field of biodegradable components and to the field of batteries.

### BACKGROUND

Increasing interest in data collection for agricultural and environmental sciences has created a need for long-term soil monitoring by wireless sensors. However, implementation of such sub-surface sensors may require on-board power, both for sensor functionality as well as wireless communication. Accordingly, there is a long-felt need in the art for power sources for such sensors, in particular for biodegradable power sources.

### SUMMARY

To address this issue, presented here are metal-air (for example, Zn-air) batteries built from biodegradable materials that can operate on or under the soil. Illustrative wax-encapsulated Zn-air electrochemical cells (‘batteries’) were fabricated based on thin film anodes, catalyst-bearing paper cathodes, and biodegradable gel electrolyte. Example batteries provided a stable output voltage of over 1.2 V in soil for weeks and even months under relevant sensor discharge conditions.

The disclosed approach provides a number of advantages. First, the disclosed power cells can be incorporate into devices that allow for local subsurface soil analysis of nutrient level available to plants. As but some examples, the disclosed power cells associated with sensors measuring any one or more of pH, oxygen, nitrogen and phosphates in order to determine if a plant is in an environment that allows the plant to thrive.

The sealed packages of the disclosed power cells protect the power cells from the external environment but still allow enough gas flow for an effective Zn-Air battery. The disclosed power cells are comparatively small in size—and can be on the order of the size of a kernel of corn—and can thus be planted using existing seeder or planter equipment. Further, the disclosed power cells can be biodegradable, thereby reducing their environmental impact.

In one aspect, the present disclosure provides a power cell, comprising: a metallic anode; an air cathode; an electrolyte, the electrolyte placing the metallic anode into electronic communication with the air cathode; and an enclosure, the enclosure encapsulating therein the metallic anode, the air cathode, and the electrolyte. An enclosure can optionally preferentially permit passage of oxygen into the enclosure relative to passage of at least one of water and CO₂ into the enclosure, and the enclosure comprising a biodegradable material. As described elsewhere herein, an enclosure can define therein one or more air paths to admit into the enclosure while also reducing the exposure of the active components of the power cell to the environment. Such a path can be, for example, the void left behind when a wire or other element is removed from the enclosure. Such a path can be, for example, between a wire extending at least partially into the enclosure and the material of the enclosure.

Also provided is a method, comprising implanting a power cell according to the present disclosure into a soil environment.

Further disclosed is a method, comprising assembling a power cell according to the present disclosure.

Additionally provided is a method, comprising powering a device using a power cell according to the present disclosure.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various aspects discussed in the present document. In the drawings:

FIG. 1: cross-section of an example fabrication process.

FIG. 2: (a) schematic of wax encapsulated Zn-air battery, (b) top view of a battery on a wax pad, (c), (d) top views of wax encapsulated batteries with and without airholes, (e) side view of a battery with wax package, (f) top view of a clamp board battery.

FIG. 3: (a) top view of a battery tested in soil, (b) front view of battery soil test set-up.

FIG. 4: discharge curves of batteries in various packages in the air and in soil.

FIG. 5: discharge curves of wax encapsulated batteries (no hole) with different gels in the soil environment.

FIG. 6: power curve of the carbon paper cathode with 80 mg of gel electrolyte.

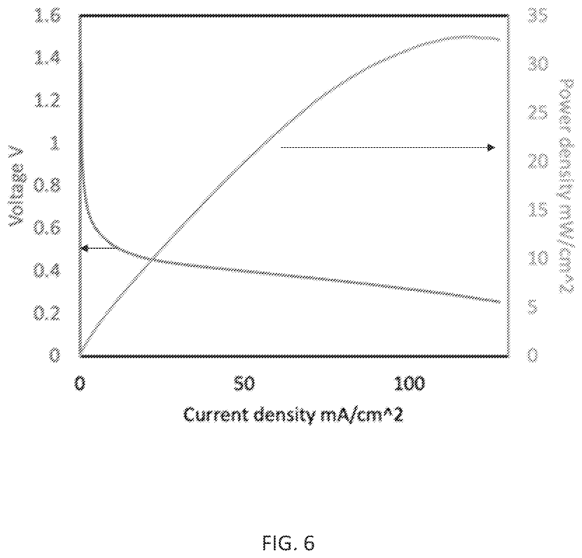

FIG. 7: discharge profile of a battery with a carbon paper cathode at a constant discharge current of 1 mA in air.

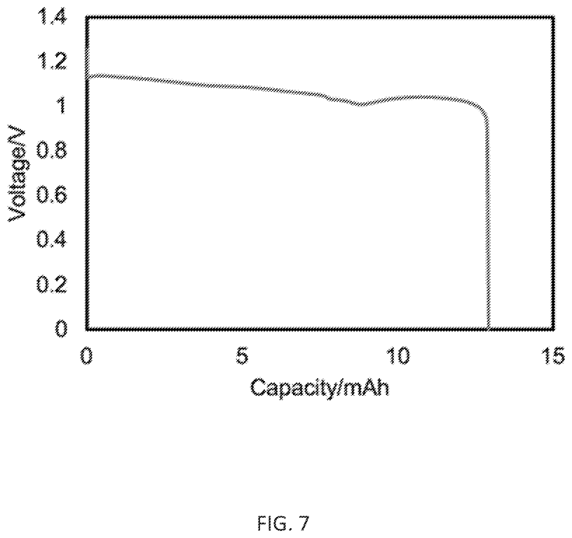

FIG. 8: (a) an optical sensor with sensing tip encapsulated in wax package to measure the air diffusion through wax, (b) an optical oxygen sensor buried in soil with a protective porous tube to measure the air diffusion through soil, (c) an optical oxygen sensor with sensing tip encapsulated in corn sized package buried in soil to measure the air diffusion through wax and soil, (d) text box.

FIG. 9: (a) the oxygen sensor reading of a wax package without any air holes, wet soil (at 5 cm depth) and the wax package buried in soil, which indicates the oxygen diffusion, (b) the corresponding current calculated from the oxygen level profile of the corn-sized package buried in soil.

FIG. 10: example discharge curves of wax encapsulated batteries (no hole) with 250 mg of gel electrolyte with and without corrosion inhibitors in the air.

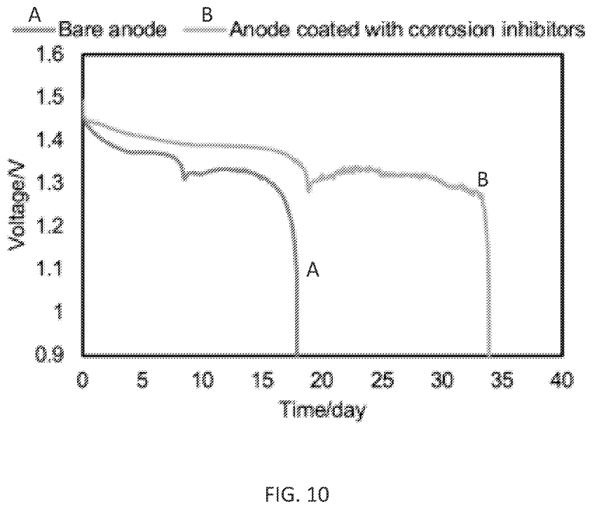

FIG. 11: (a) discharge curves of batteries with microporous paper cathode, (b) power curve of the carbon paper cathode with 200 mg of gel electrolyte without corrosion inhibitors in soil.

FIG. 12: (a) corn cell components, (b) active layers stacking on a wax pad, (c)-(f) dimensions of an assembled corn cell, (g) a corn cell next to a larger call, (h) open circuit voltage of a corn cell, (i) corn cell with half-open-air-holes before dip coating the outer layer of wax, (j) a corn cell with half-open-air-holes after dip coating the outer layer of wax.

FIG. 13: (a) continuous discharge of corn cells with corrosion inhibitors, microporous carbon cathode and wax encapsulation with or without half-open-air-holes in the air or in soil, (b) pulse discharge profile (5% duty cycle) of the corn cell with corrosion inhibitors, microporous carbon cathode and wax encapsulation without any air holes.

FIG. 14: (a) comparison of power curves of the battery with neutral gel and alkaline gel, (b) comparison of discharge curves of neutral gel and alkaline gel.

FIG. 15: Depiction of cavity extending partway through the thickness of an enclosure.

FIG. 16 provides exemplary current density vs. power density data for a carbon paper electrode (lower curve) and a platinum-impregnated carbon paper electrode (upper curve).

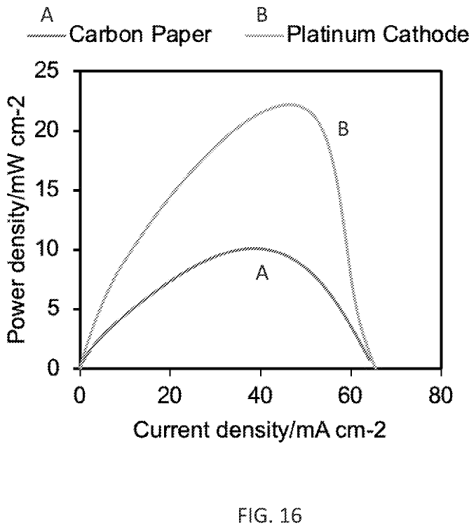

FIG. 17 provides an illustration of an example device according to the present disclosure. As shown, a device can include a power cell (also termed a battery), such as a power cell according to the present disclosure, which power cell powers a sensor. Such a sensor can be a phosphate, oxygen, or other sensor. A device can include an antenna and an RFID feature. As shown, a device can include a biodegradable encapsulant, such as a wax.

FIG. 18 provides an exemplary battery fabrication approach as well as a listing of exemplary, non-limiting component materials; also provided is a battery schematic and images of batteries made according to the present disclosure. Non-limiting dimensions for the disclosed batteries are also provided.

FIG. 19 provides general description of non-limiting characteristics observed in batteries according to the present disclosure.

FIG. 20 provides exemplary description and disclosure related to large cell performance as well as related to the use of a neutral gel.

FIG. 21 provides exemplary description and disclosure related to small-or corn cell performance as well as related to the use of biodegradable corrosion inhibitors.

FIG. 22 provides an exemplary fabrication scheme for a power cell with an enhanced wax package according to the present disclosure.

FIG. 23 provides an exemplary scheme for forming a micro air path within a power cell according to the present disclosure. Wires were embedded in wax lid and then removed after sealing the package, leaving behind a cylindrical air path, the size of which is controlled by the thickness of the wire, which can be based on the user's the power requirements. In some embodiments, an air path can be present between a wire and the enclosure. Wax infiltrated carbon paper (hydrophobic and gas permeable) was placed on top of the air path to prevent blockage caused by the irrigation, and a large cell was discharged for more than 40 days in soil, as provided in FIG. 24.

FIG. 24 provides exemplary, non-limiting performance of power cells according to the present disclosure.

### DETAILED DESCRIPTION OF ILLUSTRATIVE EMBODIMENTS

The present disclosure may be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” can include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently of the endpoints. The endpoints of the ranges and any values disclosed herein are not limited to the precise range or value; they are sufficiently imprecise to include values approximating these ranges and/or values.

As used herein, approximating language can be applied to modify any quantitative representation that can vary without resulting in a change in the basic function to which it is related. Accordingly, a value modified by a term or terms, such as “about” and “substantially,” may not be limited to the precise value specified, in some cases. In at least some instances, the approximating language can correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” can refer to plus or minus 10% of the indicated number. For example, “about 10%” can indicate a range of 9% to 11%, and “about 1” can mean from 0.9-1.1. Other meanings of “about” can be apparent from the context, such as rounding off, so, for example “about 1” can also mean from 0.5 to 1.4. Further, the term “comprising” should be understood as having its open-ended meaning of “including,” but the term also includes the closed meaning of the term “consisting.” For example, a composition that comprises components A and B can be a composition that includes A, B, and other components, but can also be a composition made of A and B only. Any documents cited herein are incorporated by reference in their entireties for any and all purposes.

Any embodiment or aspect provided herein is illustrative only and does not limit the scope of the present disclosure or the appended claims. Any part or parts of any one or more embodiments of aspects can be combined with any part or parts of any one or more other embodiments or aspects.

Recent advances in sensor fabrication, wireless communication, and data analysis have led to the establishment and widespread implementation of wireless sensor networks (WSNs). Such networks can be a powerful tool for monitoring large physical areas in a variety of applications, including the natural environment as well as agriculture [1]. The deployment of a variety of subsurface sensors that monitor ambient conditions such as soil moisture, temperature and nutrient level, enable collection of accurate information of the field or farm in real time [2]; such information can be used to drive subsequent agricultural optimizations or interventions in the field.

As a WSN typically operates in a long-term, continuous mode, available energy resources become one of the most crucial challenges. This problem is exacerbated by the need for periodic data collection, node-level or cluster-level data processing, and data communication over the potentially long distances between the sensor nodes and gateways or base stations [1], [3]. Such subsurface sensor networks are often expected to operate without human intervention; however, in many applications, they are expected to be deployed in areas away from convenient access to the established energy grid. Although conventional on-board energy sources could be used to power these sensors, it would be time-consuming and costly to re-collect the sensing systems after the functional lifetime of the sensors has expired, or to replace the energy sources once they are depleted. One solution to this problem is onboard energy sources that can power the subsurface sensors during their functional lifetime, and passively degrade in an environmentally benign fashion after use or exhaustion. Our goal is to develop such long-lifetime, biodegradable, primary energy sources (biodegradable electrochemical cells, or ‘biodegradable batteries’), and assess their performance in in-soil conditions.

Selection of the active materials of a conventional battery is mainly based on their performance and electrochemical stability. In contrast, the material requirements for biodegradable batteries are more stringent, considering that not only do the batteries need to exhibit good electrochemical performance and stable output over the operation lifetime, but have the additional constraint of passive degradation into nontoxic products, especially in agricultural settings [4].

Metal-air batteries have attracted significant attention due to their high theoretical energy density and high specific capacity compared to commercial Li-ion batteries. A typical metal-air battery comprises a metal anode and an air cathode (normally comprised of a gas diffusion layer and a catalyst layer) [5]-[7]. The anode and cathode are separated by an electrolyte. The metal is oxidized into metal ions at the anode, while oxygen from the ambient air is absorbed and reduced to hydroxide ions in presence of H₂O at the cathode. In such batteries the oxidant is not stored within the battery volume but instead is extracted from the ambient; this approach enables high energy density, a more compact battery structure, and the potential for reduced environmental impact of the battery (since less material is introduced at the cathode side).

Among the metal-air batteries, Zn-air, Li-air, Al-air and Mg-air have been widely researched [8]. Of this materials set, Mg and Zn are the most popular biodegradable metals previously utilized in transient batteries [4], [9]. Though Mg-air batteries have higher theoretical capacity, their large polarization and high self-corrosion rates make them less favorable for long term applications [10]. Zn-air batteries are a very promising power source for biodegradable sensing systems, due to their high theoretical specific energy density (1084 Wh/kg), abundance of raw materials, safety, low cost, flat discharge voltage, and relatively low corrosion rate [7].

In addition to anode materials, the packaging, electrolyte/separator, and cathode must also be considered. For the package, blends of natural waxes such as those derived from soy and beeswax can be used. For the separator, the biodegradable and water-soluble polymer poly-(vinyl alcohol) (PVA) can be formed into a hydrogel that functions both as the host of an alkaline or neutral electrolyte as well as a separator for Zn-air batteries. The fabrication process for such electrolytes was reported. For the cathode, commercially-available Platinum (Pt) loaded air cathodes can be considered, especially for laboratory testing. Functional carbon electrodes, including nanostructured carbon and doped carbon, may be lower cost alternatives to Pt-loaded cathodes [13]. In addition to wax, one can also use synthetic biodegradable polymers such as poly-lactic acid, polyglycolic acid, polycaprolactone, and other such materials known in the literature. One can also use natural products, for example cellulose and its derivatives.

Air batteries are typically characterized in air or oxygen [14], [15]. Week-long subsurface lifetimes of batteries have been achieved. Preliminary characterization of Pt-free carbon paper cathodes, typically used as a gas diffusion layer for fuel cells, suggests the carbon-based materials can be promising replacements of Pt cathodes for low-power long-term application.

### Experimental

### Active Battery Components

For anodes, commercial zinc foils (99.9% pure, 250 μm Sigma Aldrich) were patterned into example disks with strip using an IPG Microsystem IX-200-F green laser (532 nm). The disk was 1 cm diameter and comprises the electrochemically active area of the anode, while the strip is utilized for external electrical connection. For air cathodes, commercial Platinum Black paper (4 mg cm⁻² loading, Fuel Cells Etc.) and carbon paper (Sigracet 22 BB, Fuel Cells Etc.) were purchased and cut into 1 cm diameter discs using a hollow steel punch. Hydrogel electrolyte sheets were fabricated by solution-casting followed by rehydration [2]. 1.5 mg PVA (87-89% hydrolyzed, high molecular weight, Alfa Aesar) was first dissolved in 10 g of deionized water at 85 °C. An alkaline solution was prepared by dissolving 1.5 g KOH and 0.64 g K₂CO₃ in 10 g deionized water. After cooling both solutions, the alkaline solution was added to the PVA solution dropwise. The resultant PVA-KOH—K₂CO₃ precursor was then cast onto a glass petri dish, dried in a desiccator, and immersed in saturated KOH—K₂CO₃ solution for more than 2 days. After gel removal from the rehydration solution, discs with a diameter of 1.27 cm were cut from the gel using a second hollow steel punch (this slightly larger gel disc area prevents any short circuit contact between anode and cathode). Gel discs of different mass and thickness were realized by controlling the amount of the precursor used in the gel casting stage.

### Assembly and Packaging

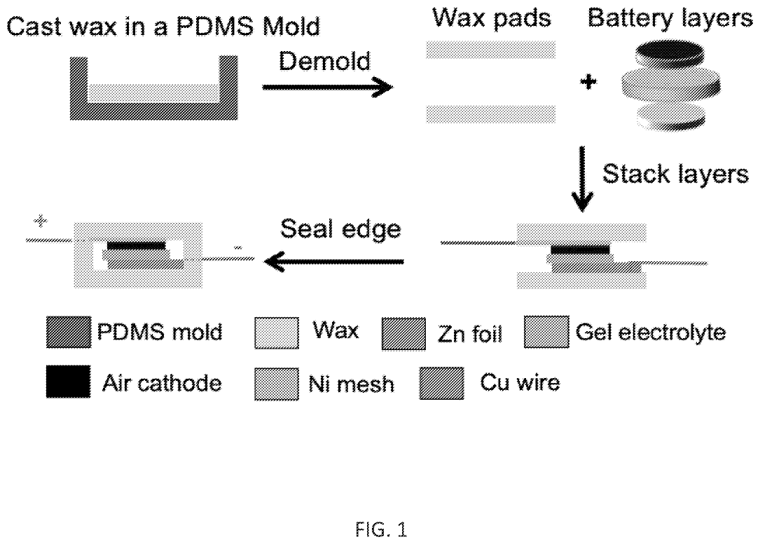

FIG. 1 illustrates a cross-section of a wax encapsulation and packaging process. Two types of wax encapsulated batteries, with and without airholes, were fabricated using this method. The preparation of the wax itself is adopted from [11]. Beeswax and soy wax were mixed in a 1:3 mass ratio, melted at 80 °C, and cast in a PDMS mold (10:1 pre-polymer/curing agent, cured at 80 °C). The top and bottom encapsulation pads were demolded after solidification at room temperature. Open airholes were optionally introduced to the top wax pad (the one closest to the cathode side) by using a needle to punch through the pad. The three functional layers of the battery were then sandwiched between the pads, with a thin layer of Ni mesh contacting the cathode side to facilitate testing. Both Ni mesh and anode handle were attached to insulated Cu wires by silver paste for secure external connection. Finally, the four edges of the two pads were manually sealed by melted wax with interconnects enclosed to avoid parasitic leakage current when the battery is discharged in soil.

Reference batteries without packaging were also tested using a clamp board technique. Pairs of acrylic clamp boards with a porous structure in one board were fabricated by CO₂ laser machining and used to immobilize the active battery stack; a pair of screws extending between the boards could be tightened to clamp the active stack together.

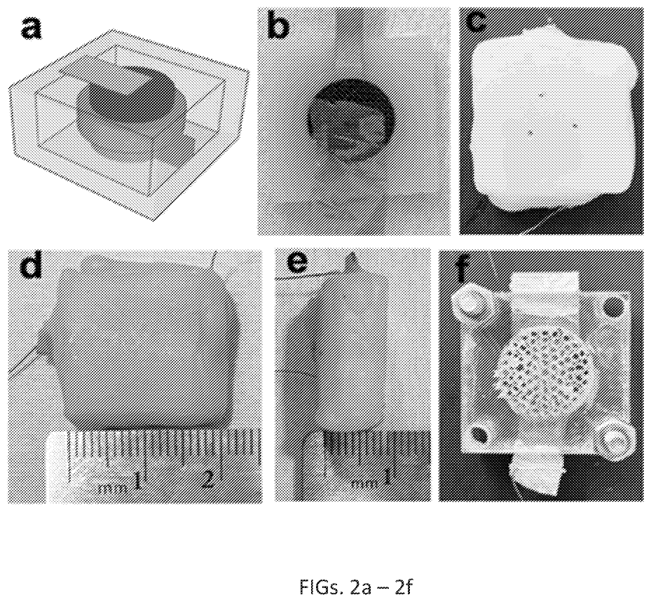

Referring to FIG. 2, FIG. 2(a) shows a schematic of the wax-encapsulated battery, and FIG. 2(b) shows the detail of how the nickel mesh structure is attached to the battery cathode. FIG. 2(c)-FIG. 2(f) show wax encapsulated batteries with and without air holes, as well as a typical clamp board reference battery.

### Test Environments

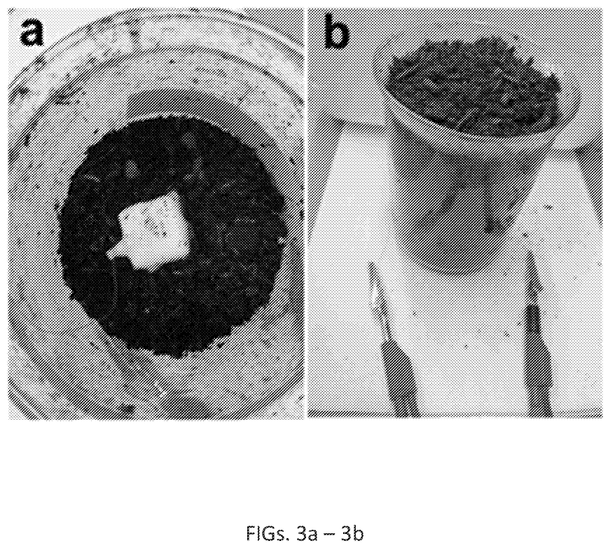

To characterize in-soil performance, the batteries were placed in organic raised bed soil (Harvest Organics, Lowe's) inside 600 ml beakers at a controlled buried depth of 5 cm. FIG. 3(a) shows a wax encapsulated battery in a beaker half-filled with soil. After the battery was placed, extra soil was placed on top until the desired depth is reached as shown in FIG. 3(b). Copper wires extend from the buried battery to the anodic and cathodic clips of a battery cycler. Batteries of similar packages and gel masses were also tested in the air as references to the in-soil-tested devices.

### Performance Characterization

Electrochemical assessment was performed using a BioLogic BCS-805 Ultra-Precision battery cycler. A 10-minute open circuit potential test was first carried out to stabilize the batteries in their respective environments. A current-voltage (I-V) curve to demonstrate the power capability of the battery was then performed through a galvanodynamic test with a scan rate of 5 mA/s from 0 to 100 mA. Battery performance was then characterized by chronopotentiometry testing. Batteries with Pt loaded cathodes were discharged at 30 μ A, which is selected based on the power requirements of both MEMS fabricated oxygen sensors as well as RFID chips [16], [17]. A higher discharge current of 1 mA was utilized when characterizing the carbon paper cathodes to understand their catalytic performance in the absence of Pt. A typical 0.9 V cut-off voltage was taken as an endpoint of battery operation.

### Results

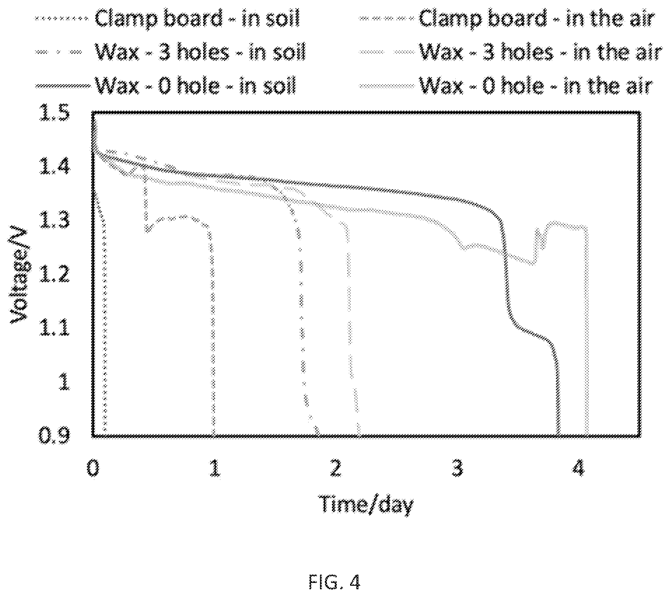

A notable characteristic of air batteries is that their need to access ambient oxygen typically requires some degree of exposure to the environment. The performance of the battery may therefore be significantly affected by multiple variables in its operating environment. To assess these effects, batteries were characterized in multiple environments (air, 5 cm deep in soil) and with multiple degrees of environmental exposure (clamp board, wax package with air holes, wax package with no holes) as shown in FIG. 4. In these tests, the gel electrolyte mass was held constant at 38 mg to eliminate the effect of the amount of gel.

The lifetime of the batteries discharged in the air were longer than the ones in soil for all three types of packages. This might be due to the influence of the soil condition. Soil is a porous structure containing solid particles, water and gas [18]. The relative humidity of the soil gas is close to 100% which is much higher than the air [19]. The alkaline electrolyte could absorb more water from the ambient environment when the battery is buried under soil, which could possibly lead to lower concentration of the OH in the gel electrolyte. As the solubility of intermediate zincate ion product at the anode side reduces with decreased pH, the zincate ion may reach the supersaturation point earlier and decompose to ZnO, resulting in more rapid passivation of the anode [15].

Another potential mechanism behind the variation of the lifetimes of batteries is carbonation. The OH⁻ ions in the hydrogel provide the ionic conductivity for the battery. While theoretically no OH⁻ will be consumed in the overall reaction, CO₂ in the air can diffuse together with O₂ into the battery, and react with the OH ions in the alkaline electrolyte to form CO₃²⁻ or HCO₃⁻, which have much higher ionic resistivity than OH [20]. Since the amount of gel electrolyte is a relatively small 38 mg, the OH⁻ could be consumed gradually over time (as well as the electrolyte pH falling over time) as the battery discharges. When the concentration of OH⁻ falls too low, the reduced ionic conductivity can induce a large overpotential, leading to the end of discharge.

Clamp board batteries are the most vulnerable to such environmental variables, since CO₂ and moisture can access the battery not only from the maximally exposed porous structure at the cathode side, but also from side openings. It was thus not surprising to observe that the discharge lifetime of the clamp board batteries was the shortest. Wax-encapsulated batteries with air holes sustained a much longer discharge lifetime, perhaps due in part to the hydrophobic nature of the waxes, which results in extremely low water vapor permeability [21], as well as increased mass transfer limitations between the ambient and the porous cathode.

The wax-encapsulated battery with no air holes provided the longest lifetime both in the air and in soil. Without being bound to any particular theory or embodiment, this might be due to its minimal exposure to the CO₂ and water vapor in the air and soil gas. One possibility is that even though there are no nominal air paths to the ambient, imperfections in sealing result in parasitic air paths sufficient to sustain battery discharge. Another possibility comes from noting that even though the wax has low water vapor permeability, it is permeable to oxygen [21]. The long continuous discharge suggests that even with no nominal air holes, these mechanisms can sustain the low discharge current of 30 μA and fulfill the power requirement of the subsurface sensors.

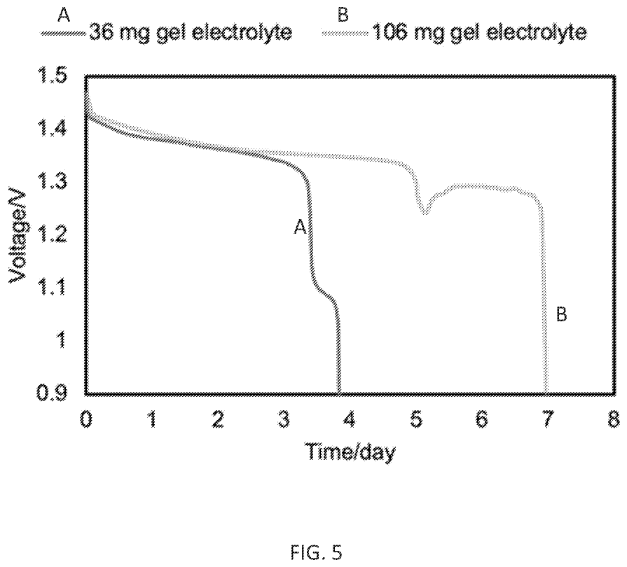

Since batteries fully encapsulated in wax with no nominal air holes result in superior discharge performance over other packages both in the air and in soil, this geometry was chosen to determine the effect of gel electrolyte mass on battery lifetime. As shown in FIG. 5, an increase in the gel mass from 36 mg to 103 mg resulted in an 80% increase in battery discharge lifetime, supporting the hypothesis that the gel electrolyte can limit the performance of the batteries when its mass is low. Remarkably, the fully wax-encapsulated battery with 103 mg gel electrolyte provided a constant output voltage of over 1.2 V for 7 days in soil under a constant 30 μA discharge current. As shown, one can replace the air cathode bearing a Pt catalyst with carbon fiber paper. Although replacing Pt with carbon raises the issue of the relatively low catalytic activity of carbon leading to a higher energy barrier for the cathodic reaction and poorer power performance of the air battery [13], it is noted that in many of these WSN applications, low power output is acceptable.

### Additional Disclosure

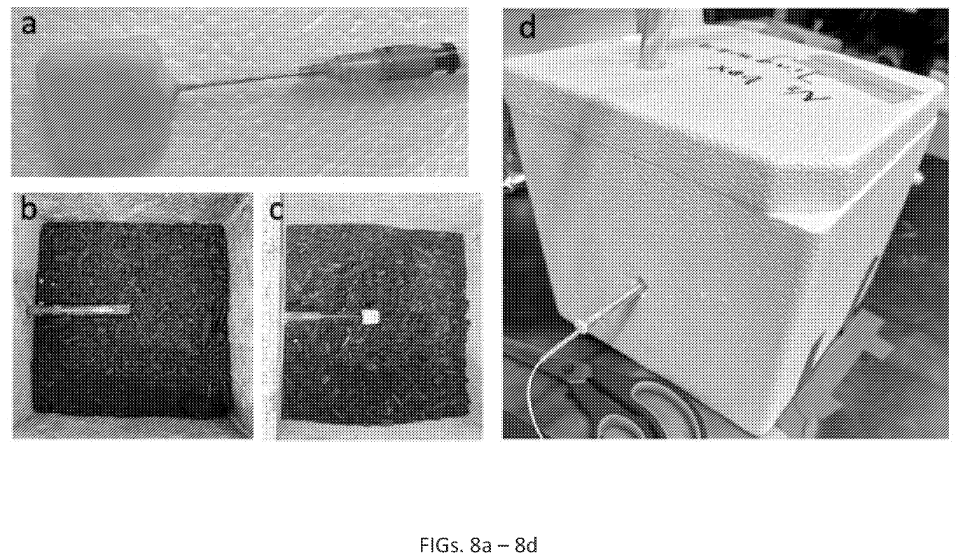

To demonstrate the functioning of these air batteries with no open air holes in the soil environment, we monitor the oxygen level over time in the soil and in the wax package using commercial optical oxygen sensor. To deplete the oxygen inside of the wax package/in soil, compressed N₂ is communicated into a closed box. The oxygen sensor tip encapsulated in the wax packages of different sizes or protected by a porous tube, is put into the N2 box (with or without soil). After the oxygen reading falls and stabilizes at the minimum value (around 3%), the cap of the N2 box was opened and oxygen from the ambient environment will diffuse in. FIG. 8 shows the oxygen diffusion test set-up.

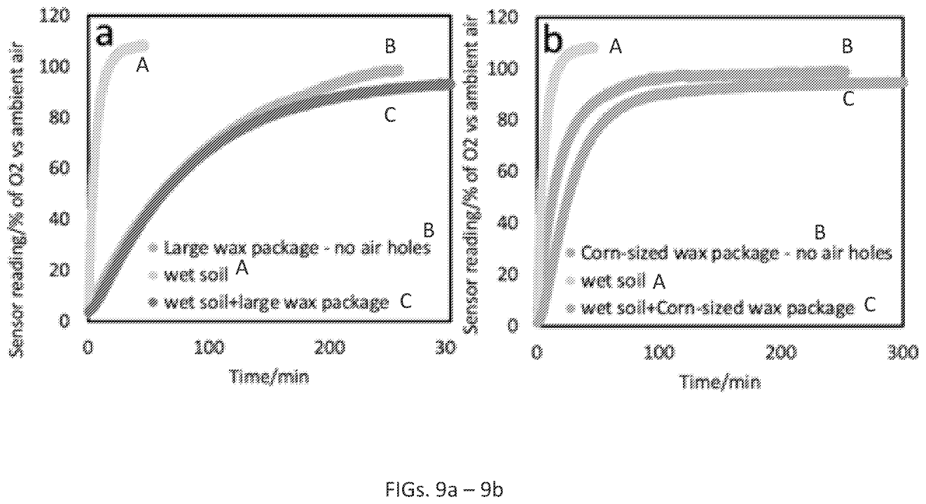

From the experimental results of the oxygen concentration profile versus time collected by the commercial oxygen sensor as shown in FIG. 9, the limiting current of the wax package battery in soil can be derived and the value is about 116 uA, which supports that the flux of the air diffusing through the soil and large wax package without any open air path can fulfill the operational power requirements of the sensors (30 uA).

We have extended the lifetime of the battery by increasing the amount of the gel electrolyte. FIG. 5 shows that an increase in the gel mass from 36 mg to 103 mg resulted in an 80% increase in battery lifetime.

A mixture of biodegradable polymers poly(ethylene glycol 600) and poly(sorbate 20) can be used as a corrosion inhibitor for Zn/MnO₂ button batteries to suppress the self-discharge of the Zn anode and improve the discharge capacity of the battery (J Appl Electrochem 41, (2011), 991-997). We applied this technique to our biodegradable batteries. By coating the Zn anode with a thin layer of corrosion inhibitors, the corrosion current reduces from above 200 μA to below 20 μA, and the battery lifetime was elongated by 90% as shown in FIG. 9. Thus, the anode of the disclosed power cells can include a corrosion inhibitor; such an inhibitor can be—but does not have to be—a mixture of biodegradable polymers poly(ethylene glycol 600) and poly(sorbate 20).

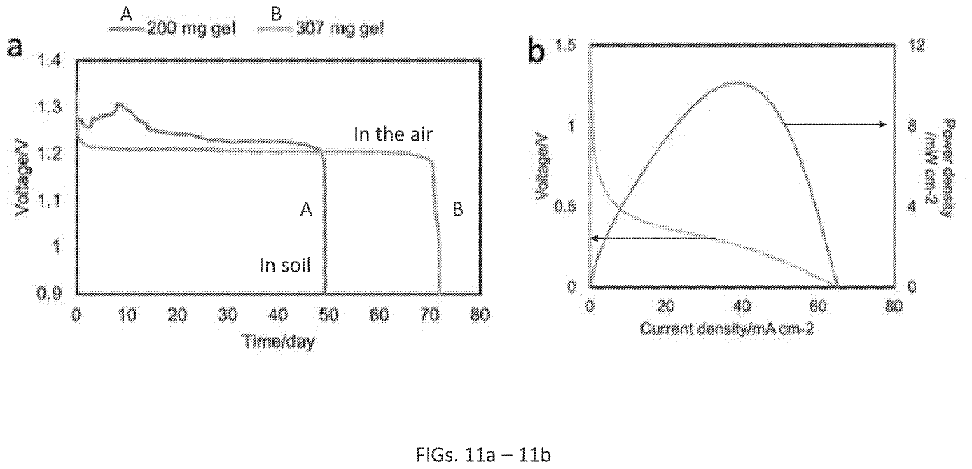

To increase the biodegradability of the battery and reduce the cost, we have replaced the air catalyst Pt with microporous carbon. The battery with the carbon-impregnated paper cathode discharged for 50 days at a sensor-relevant 30 μA in soil. By increase the mass of the gel electrolyte, the lifetime is extended to over 70 days. A peak power using this cathode was also measured to be 10 mW cm⁻², as shown in FIG. 11.

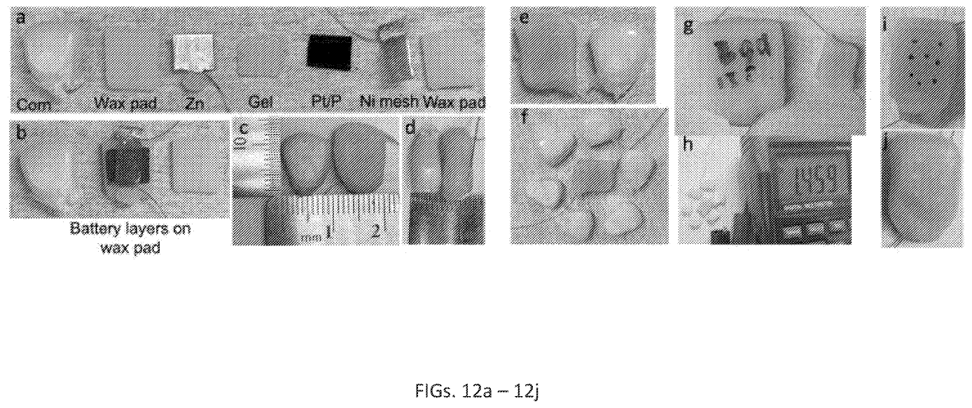

We have also miniaturized the batteries to the size of a corn kernel for the deployment, for example, with agricultural machines. We further demonstrated that the wax encapsulation technology developed can be applied for corn cells. FIG. 12 shows example ‘corn cell’ components and dimensions.

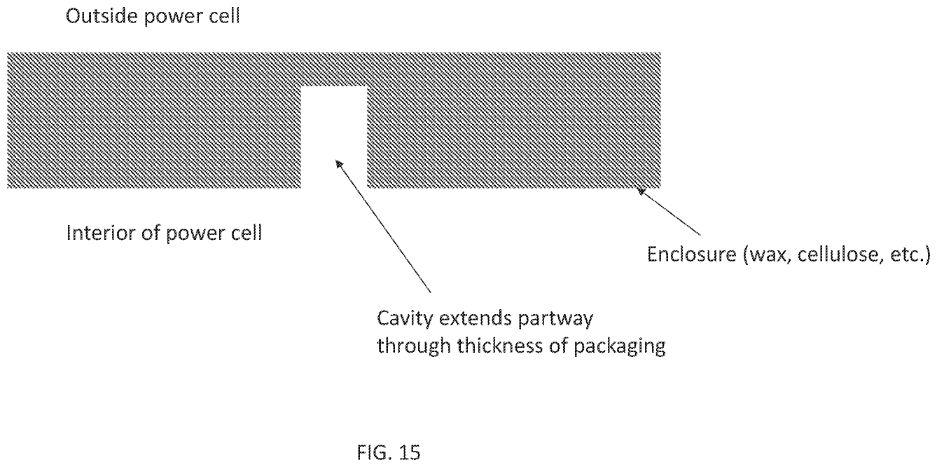

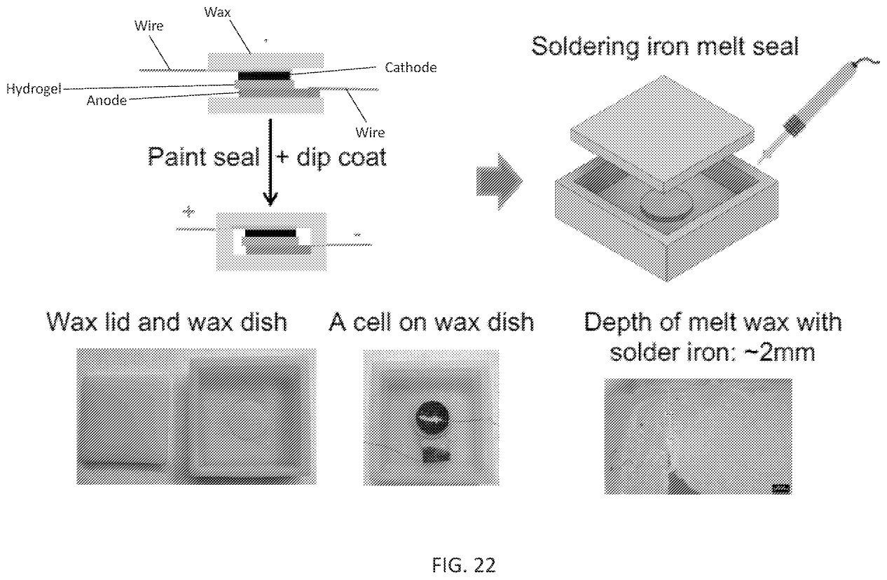

When the corn cell is discharged in soil, an unstable output voltage has been observed which is possibly due to the relatively lower oxygen diffusion rate. In order to increase the air flow in the corn cell, 8 air holes are opened on the wax pad on the cathode side. Meanwhile, to avoid direct exposure to the moisturized soil environment, the corn cell is dip coated with a thin layer of wax as a shell to cover the air holes, resulting in a thinner region of wax suspended over the air holes; an example of such a configuration is provided in FIG. 15, which depicts a cavity extending partway through the thickness of an enclosure. This innovation allows both designable and improved oxygen transport to the cell but maintains isolation from the environment. With this construction, the corn cell discharged in soil for 15 days. An air path can also be formed, for example, in the gap between a wire and the enclosure. For example, and by reference to FIG. 22, an air path can be present in a space between a wire and the wax enclosure.

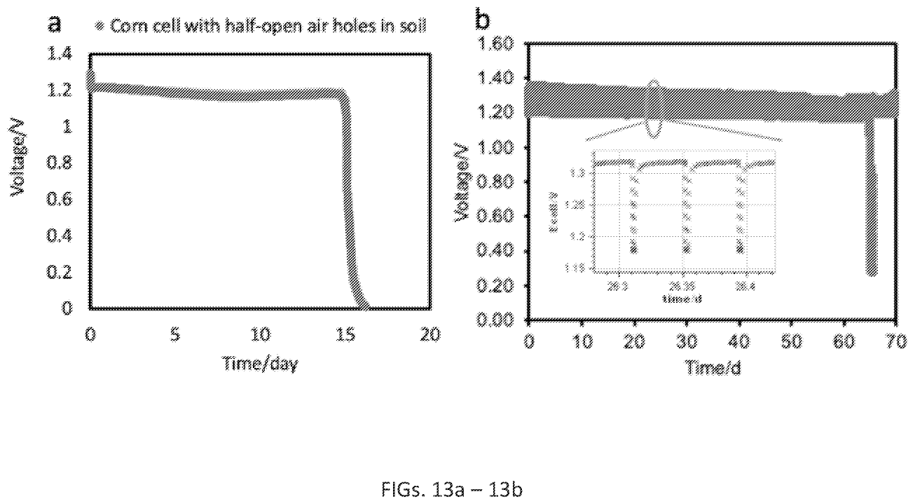

A corn cell with anode corrosion inhibitors and micro-porous cathode lasted over 18 days in air under constant 30 μA discharge as shown in FIG. 13(a). To minimize the energy consumption and maximize the operational lifetime of the sensing node, the sensing system will typically operate on a duty cycle, waking up from time to time to collect data. The corn cell is also tested with a duty cycle to mimic the real case scenario. FIG. 13(b) shows that with 5% duty cycle (discharge 3 mins in an hour), the corn cell lasts over 65 days in air.

The electrolyte can be neutral, acidic, or even alkaline. It has been reported that NH₄Cl serves as buffer to maintain electrolytes' neutral pH, avoiding Zn electrodes' corrosion. Without being bound to any particular theory or embodiment, neutral gels present particular advantages and are this suited to long-term operation. As an example, the use of a neutral gel can reduce or even avoid the degradation mechanisms of alkaline gel electrolyte, including the carbonate due to the exposure to CO₂ from the ambient air, and the degradation of the PVA under high pH for long. Again without being bound to any particular theory or embodiment, a neutral gel can also have a better water retention ability, as the O—H ···N bond can trap water molecules.

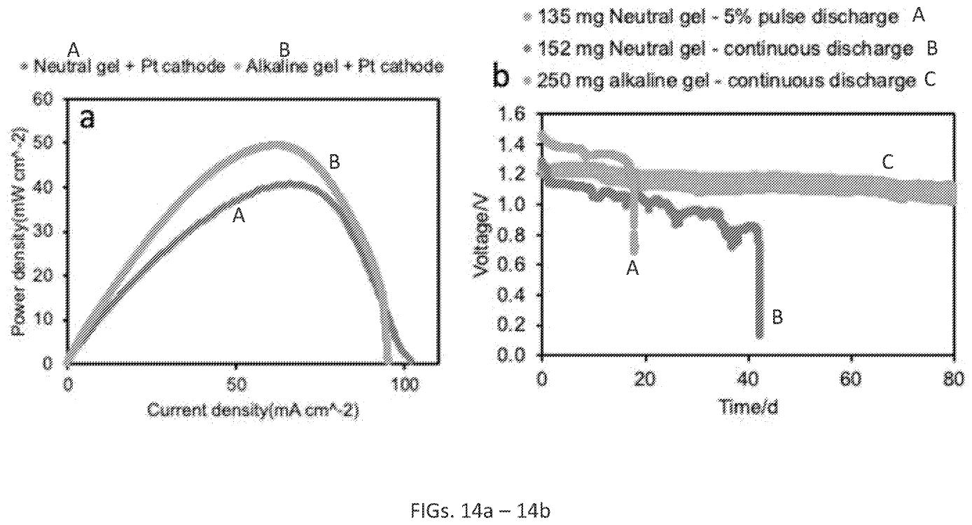

Suppression of self-corrosion for Zn is less active in neutral electrolytes. First several batch of neutral gels has been fabricated and tested. The fabrication of the neutral starts with the preparation of the neutral precursor containing PVA, NH₄Cl and DI water, followed by solution cast method with freeze-thaw three times to form the gel film. As shown in FIG. 14(a) and 14(b), the lower peak power and working voltage of batteries with neutral gels are lower than that of the alkaline gel, which is potentially due to the slower oxygen redox kinetics in neutral electrolytes. FIG. 14(b) shows the neutral gel has higher and stabler working voltage under a 1/20 duty cycle, which discharges for over 80 days. One can see that the lower mass of the neutral gel can discharge much longer than alkaline gel under 30 uA current load and is thus especially suitable for long-term low power applications.

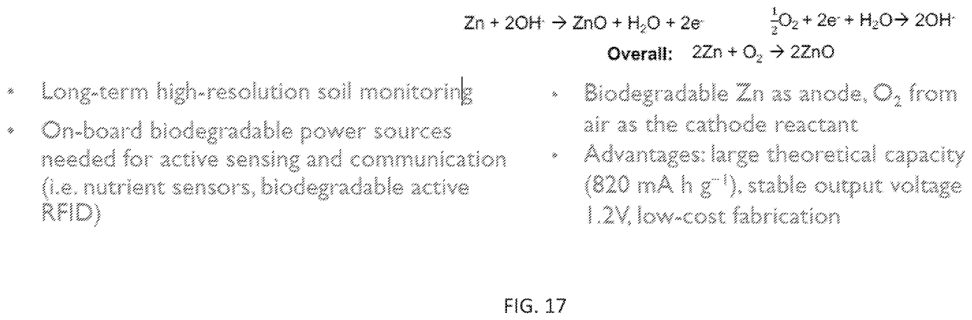

As shown in FIG. 17, an example device according to the present disclosure can include a power cell according to the present disclosure, which power cell powers a sensor. Such a sensor can be an oxygen sensor; a sensor can be another sensor as well. A device can include an antenna and an RFID feature. As shown, a device can include a biodegradable encapsulant, such as a wax. Beeswax and soy wax are both considered suitable encapsulants, although other waxes can also be used. Also as shown, devices according to the present disclosure can utilize a zinc-air chemistry in which zinc serves as the anode, and oxygen from the air serves as the cathode reactant. Such an approach has a comparatively large theoretical capacity and also a stable output voltage.

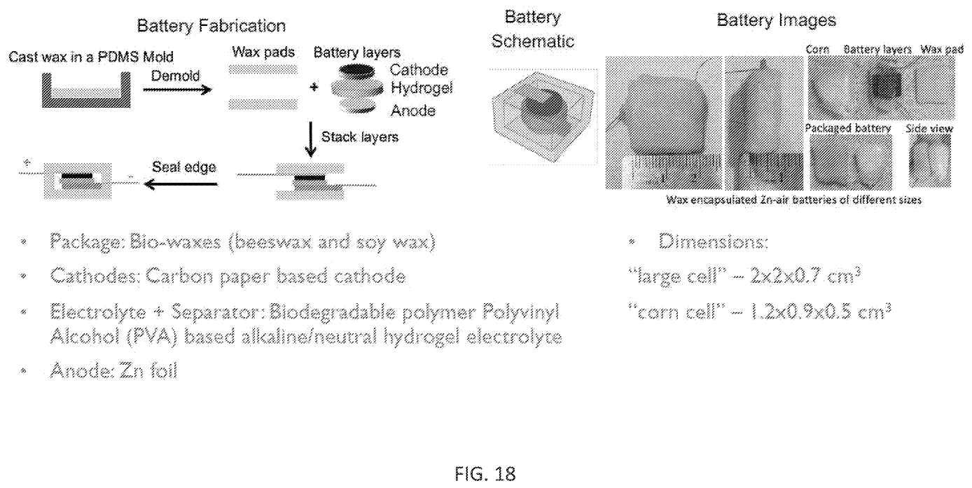

FIG. 18 provides an exemplary battery fabrication approach as well as a listing of exemplary, non-limiting component materials; also provided is a battery schematic and images of batteries made according to the present disclosure. Non-limiting dimensions for the disclosed batteries are also provided. As described, beeswax and soy wax are considered suitable encapsulants. A cathode can be, for example, a carbon paper or other conductor; carbon paper is considered especially suitable.

A separator can be, for example, a biodegradable polymer. The electrolyte can be, for example, a PVA-containing electrolyte. The electrolyte can be a hydrogel; the electrolyte can also be neutral or even alkaline. The anode can be a zinc foil. As shown, power cells according to the present disclosure can have a cross-sectional dimension—such as a width, height, or length—in the range of 5 cm or less, for example, 2 cm or even 0.5 cm, as shown. The thickness of a power cell's anode, gel, and cathode can be, for example, from about 1.5 to about 5 mm, such as 2 mm to about 3 mm. A power cell can be round in cross-section; a power call can also be polygonal in cross-section. As but one example, including the wax package, the outer dimension of a power cell can be 2×2×0.7 cm, for example, or 3.5×3.5×1.2 cm. Without being bound to any particular theory or embodiment, a so-called “corn” cell can be dimensioned similar to the dimensions of a kernel of corn. Power cells according to the present disclosure and devices using such cells can be planted similar to seeds and can be planted using existing agricultural equipment.

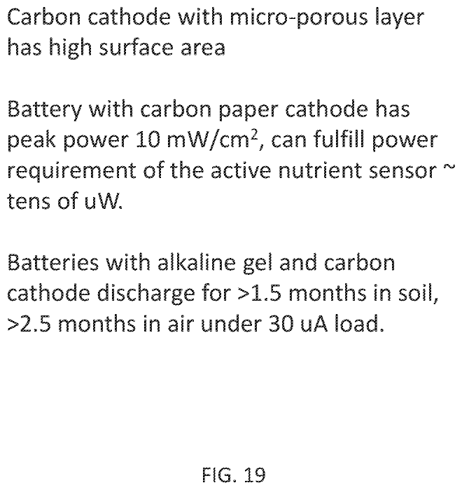

FIG. 19 provides exemplary images of alkaline gel discs, a carbon paper cathode, a microporous layer and a gas diffusion layer, as well as general description of non-limiting characteristics observed in batteries according to the present disclosure. As shown, an alkaline gel disc can be formed with PVA, KOH, K₂CO₃, and H2O. A cathode can, as described, be formed of a carbon paper; a carbon paper with a microporous layer has a comparatively high surface area. As but one example, a battery with carbon paper cathode had a peak power 10 mW/cm2, which fulfills the power requirement of the active nutrient sensor of tens of uW. Batteries with alkaline gel and carbon cathode discharges for more than 1.5 months in soil, and more than 2.5 months in air under a 30 uA load.

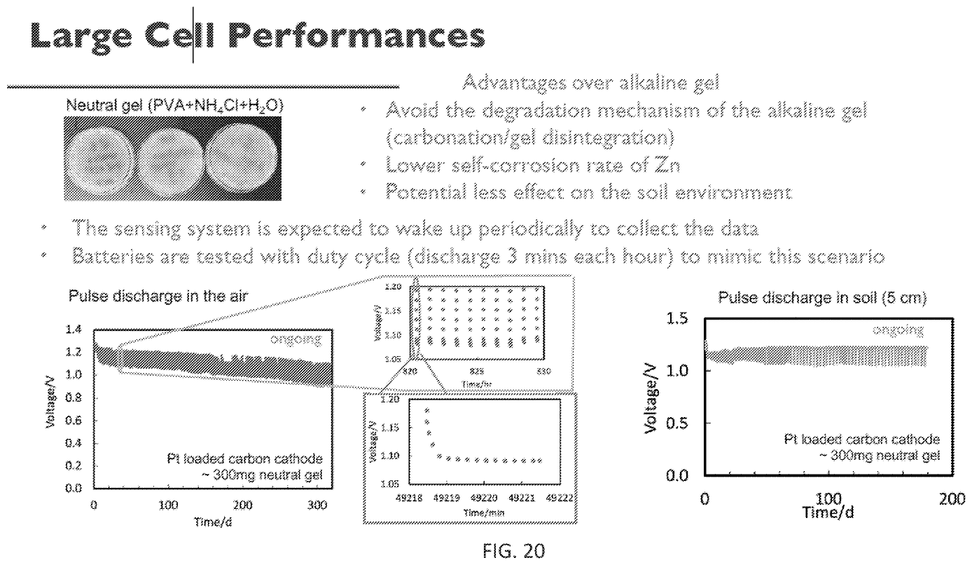

FIG. 20 provides exemplary description and disclosure related to large cell performance as well as related to the use of a neutral gel. As described, neutral gels avoid the degradation mechanisms of alkaline gels, which can be a carbonation/gel disintegration. The metallic anode can have a lower self-corrosion rate in the neutral gel as compared to that in the alkaline gel, for example, a zinc anode. A sensing system can be configured so as to operate only intermittently—as opposed to continuously—to collect data. Example power cells were tested with a duty cycle under which the power cells discharged for 3 minutes each hour. Example results are provided.

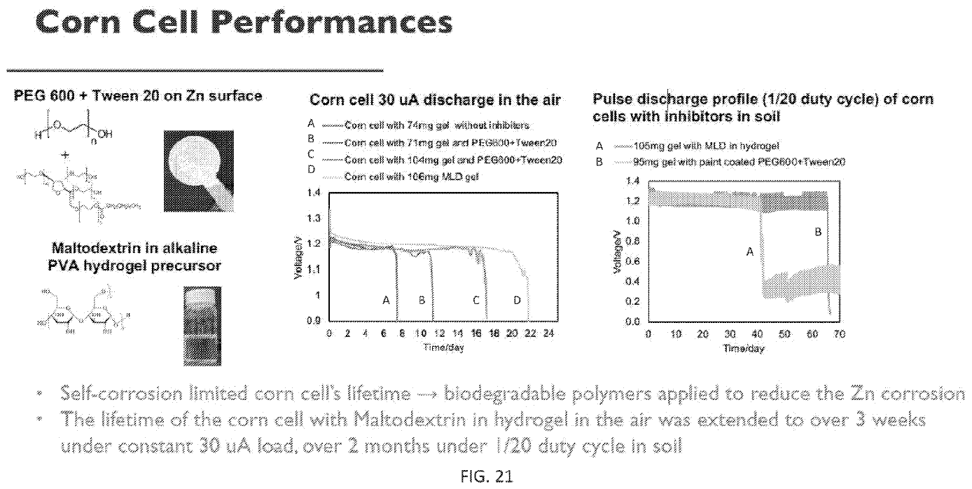

FIG. 21 provides exemplary description and disclosure related to small-or corn cell performance as well as related to the use of a neutral gel. As shown, one can apply a biodegradable polymer to reduce corrosion of the metallic anode. As an example, adding maltodextrin to the hydrogel electrolyte of a corn cell was extended to over 3 weeks under a constant 30 μA load in the air, and to over 2 months under a 1/20 duty cycle in soil.

FIG. 22 provides an exemplary fabrication scheme for a power cell with an enhanced wax package (improved mechanical property) according to the present disclosure. As shown in the upper left image, one can place a cathode, an electrolyte hydrogel, and an anode between layers of wax, with wires extending outwardly. The cathode, electrolyte hydrogel, and anode can be sealed by additional wax so as to enclose them. As shown, one can place the cathode, electrolyte hydrogel, and anode into a wax dish and then seal the dish with a lid using solder iron to locally melt the wax around the gap. The lid can comprise wax; the lid can be solid wax, but can also be a material—such as a paper—that comprises wax. As an example, waxed paper can be used as a lid.

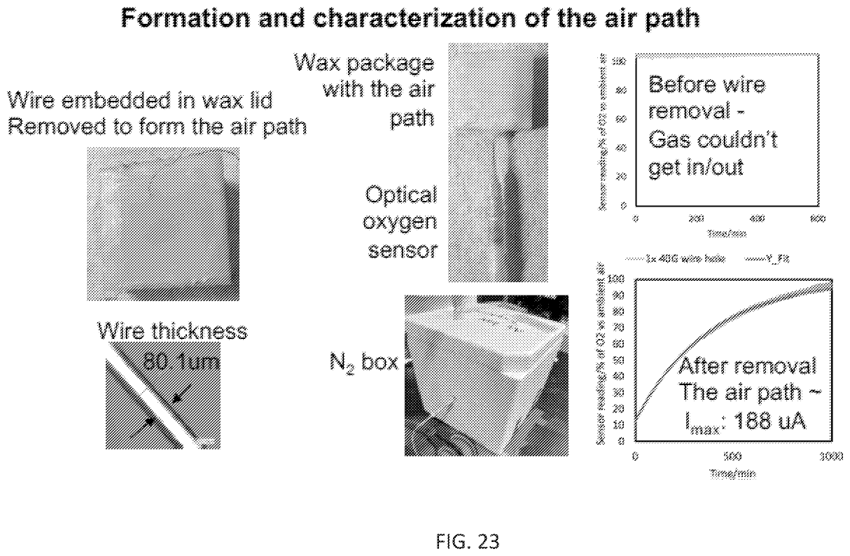

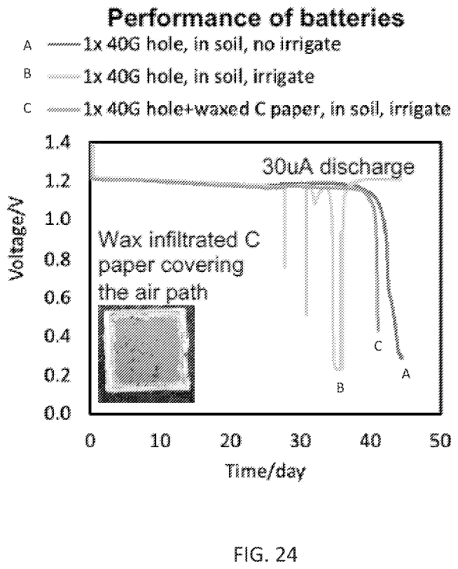

FIG. 23 provides an exemplary scheme for forming an air path within a power cell according to the present disclosure. Wires were embedded in a wax lid and then removed, leaving behind an air path, the size of which is controlled by the thickness of the wire. Wire thickness can be based on the user's the power requirements. Wax infiltrated carbon paper (hydrophobic and gas permeable) placed on top of the air path to prevent blockage caused by the irrigation, and a large cell was discharged for more than 40 days in soil, as provided in FIG. 24. It should be understood that holes can be formed in enclosures in other ways, for example, by using a needle or other penetrator to form a hole or holes in the lid. It should be understood that one can form cavities in the enclosure that do not extend through the enclosure; an example of this is shown in FIG. 15. Without being bound to any particular theory or embodiment, the thinned region created by the cavity is water resistant while also being more permeable to air than the full-thickness regions of the enclosure, thereby allowing an amount of air into the power cell while also resisting water admission.

FIG. 24 provides exemplary, non-limiting performance of power cells according to the present disclosure for (A) a power cell having a 1×40 G hole and located in non-irrigated soil, (B) a power cell having a 1×40 G hole in irrigated soil, and (C) a power cell having 1×40 G hole with wax-infiltrated carbon paper covering the air path and located in irrigated soil. As shown, power cells A and C exhibited similar performance, thereby showing the utility of using a waxed paper in a irrigated environment.

### Conclusion

We present the materials and designs of Zn-air batteries with biodegradable package and gel electrolyte. The performance of example, non-limiting batteries with wax and clamp board in the ambient air and in soil environment was characterized by 30 μA constant current discharge as well as under intermittent discharge load. Biowax encapsulation was a useful package both in air and in soil; as an example, a wax-encapsulated Zn-air battery with alkaline gel electrolyte discharged over 40 days in soil at 5 cm depth under continuous 30 uA load. Carbon paper cathodes were also tested and shown to have sufficient catalytic activity for these WSN applications. Accordingly, the disclosed power cells (which can be Zn-air batteries) are useful as biodegradable power sources to sustain long-term operation in subsurface conditions for agricultural applications.

### References

[1] P. Corke, T. Wark, R. Jurdak, W. Hu, P. Valencia, and D. Moore, “Environmental wireless sensor networks”, in Proceedings of the IEEE, 98, 11(2010 ).
[2] H. M. Jawad, R. Nordin, S. K. Gharghan, A. M. Jawad, and M.

Ismail, “Energy-efficient wireless sensor networks for precision agriculture: A review”, Sensors (Switzerland), 17, 8 (2017).
[3] S. Sharma, R. K. Bansal, and S. Bansal, “Issues and challenges in wireless sensor networks”, Proceedings—2013 International Conference on Machine Intelligence Research and Advancement, ICMIRA 2013, 2014.
[4] N. Mittal, A. Ojanguren, M. Niederberger, and E. Lizundia, “Degradation Behavior, Biocompatibility, Electrochemical Performance, and Circularity Potential of Transient Batteries”, Advanced Science, 8, 12 (2021).
[5] N. Chawla, “Recent advances in air-battery chemistries”, Materials Today Chemistry, 12 (2019).
[6] V. Caramia and B. Bozzini, “Materials science aspects of zinc-air batteries: A review”, Materials for Renewable and Sustainable Energy, 3, 2 (2014).
[7] J. S. Lee et al., “Metal-air batteries with high energy density: Li-air versus Zn-air”, Advanced Energy Materials, 1, 1 (2011).
[8] Md. A. Rahman, X. Wang, and C. Wen, “High Energy Density Metal-Air Batteries: A Review”, Journal of The Electrochemical Society, 160, 10 (2013).
[9] X. Jia, C. Wang, C. Y. Lee, C. Yu, and G. G. Wallace, “Energy materials for transient power sources”, MRS Bulletin, 45, 2 (2020).
[10] T. Zhang, Z. Tao, and J. Chen, “Magnesium-air batteries: From principle to application”, Materials Horizons, 1, 2 (2014).
[11] Y. Sui, M. Atreya, S. Dahal, A. Gopalakrishnan, R. Khosla, and G. L. Whiting, “Controlled Biodegradation of an Additively Fabricated Capacitive Soil Moisture Sensor”, ACS Sustainable Chemistry and Engineering, 9, 6 (2021).
[12] V. Venkatesh, Q. Yang, J. Zhang, J. Pikul and M. G. Allen, “Fabrication and Characterization of Evaporated ZINC Anodes for Small-Scale ZINC-Air Batteries”, 2021 21st International Conference on Solid-State Sensors, Actuators and Microsystems (Transducers), (2021), pp. 1134-1137
[13]Z. L. Wang, D. Xu, J. J. Xu, and X. B. Zhang, “Oxygen electrocatalysts in metal-air batteries: From aqueous to nonaqueous electrolytes”, Chemical Society Reviews, 43, 22 (2014).
[14] Y. Wei, Y. Shi, Y. Chen, C. Xiao, and S. Ding, “Development of solid electrolytes in Zn-air and Al-air batteries: From material selection to performance improvement strategies”, Journal of Materials Chemistry A, 9, 8 (2021).
[15] J. Stamm, A. Varzi, A. Latz, and B. Horstmann, “Modeling nucleation and growth of zinc oxide during discharge of primary zinc-air batteries”, Journal of Power Sources, 360 (2017).
[16] D. She and M. G. Allen, “A micromachined freestanding electrochemical sensor for measuring dissolved oxygen”, Journal of Microelectromechanical Systems, 28, 3 (2019).
[17] “https://www.nxp.com/docs/en/data-sheet/SL3S1003_1013.pdf.”
[18] “https://earthsoils.com/soil-composition/.”
[19] “https://www.doctordirt.org/teachingresources/idealsoil.”
[20] G. Li et al., “Carbonation effects on the performance of alkaline polymer electrolyte fuel cells”, International Journal of Hydrogen Energy, 40, 20 (2015).
[21] G. Donhowe and O. Fennema, “Water vapor and oxygen permeability of wax films”, J Am Oil Chem Soc, 70, 9 (1993).

### Aspects

The following Aspects are illustrative only and do not limit the scope of the present disclosure or the appended claims. Any part or parts of any one or more Aspects can be combined with any part or parts of any one or more other Aspects.

Aspect 1. A power cell, comprising: a metallic anode; an air cathode; an electrolyte, the electrolyte placing the metallic anode into electronic communication with the air cathode; and an enclosure, the enclosure encapsulating therein the metallic anode, the air cathode, and the electrolyte. The enclosure can include one or more air paths that admit air to the interior of the enclosure. An enclosure can preferentially permit passage of oxygen into the enclosure relative to passage of at least one of water and CO2 into the enclosure. The enclosure can comprise a biodegradable material.

Aspect 2. The power cell of Aspect 1, wherein the metallic anode comprises any one or more of Al, Fe, Mo, Mn, Mg, or Zn.

Aspect 3. The power cell of any one of Aspects 1-2, wherein the air cathode comprises a carbonaceous material.

Aspect 4. The power cell of Aspect 3, wherein the carbonaceous material comprises carbon paper.

Aspect 5. The power cell of any one of Aspects 1-4, wherein the enclosure comprises at least one of a wax and a biodegradable plastic.

Aspect 6. The power cell of Aspect 5, wherein the wax comprises a natural wax or a naturally-derived wax.

Aspect 7. The power cell of Aspect 6, wherein the wax comprises beeswax, soy wax, or a wax derived from any one or more of beeswax, soy wax, candelilla wax, and myrtle wax.

Aspect 8. The power cell of Aspect 5, wherein the biodegradable plastic comprises any one or more of polylactic acid, polyglycolic acid, polycaprolactone, cellulose, or a cellulose-derived material.

Aspect 9. The power cell of any one of Aspects 1-8, wherein the electrolyte has a neutral pH or an alkaline pH.

Aspect 10. The power cell of any one of Aspects 1-9, wherein the electrolyte comprises a hydrogel. Hydrogels having a neutral pH are considered particularly suitable. A hydrogel can include an additional polymer, such as a biodegradable polymer, therein. The additional polymer need not be part of the hydrogel matrix. As an example, maltrodextrin can be included in the hydrogel's precursor. A polysorbate, such as polyethylene glycol sorbitan monolaurate, Polyoxyethylenesorbitan monolaurate; polysorbate 20, polysorbate 40, polysorbate 60, or polysorbate 80 can be used. One can also place a sealant on the surface of the anode; for example, one can place a surfactant and a polyethylene glycol on the surface of the anode. As described herein, one can place a polyethylene glycol and a polysorbate on the surface of the anode. Without being bound to any particular theory or approach, mixed polymer exhibited corrosion suppression that was superior to the effect seen from using a single polymer. Again without being bound to any particular theory or embodiment, one can apply a polymer or polymer mixture to the surface of the metallic anode, which can be Zn. Further without being bound to any particular theory, the hydrophobic tail of a polymer can extend from the anode surface, protecting the anode from corrosion.

Aspect 11. The power cell of any one of Aspects 1-10, wherein the enclosure is free of pores extending therethrough.

The foregoing is not a requirement, however, as an enclosure can include one or more pores extending therethrough. As an example a pore can be formed by penetrating the enclosure with a needle; a pore can also be formed by removing a wire or other element that extends through the enclosure, thereby leaving behind an aperture in the enclosure, as shown in FIG. 23. One can place a sealing material over an aperture (also termed an “air path” in some embodiments). Such a sealing material can be a wax paper, such as a wax-infiltrated carbon paper or other paper.

For example, one can form holes in the lid of an enclosure—for example, by removing wires embedded in the enclosure. One can then place a wax-infiltrated carbon paper sealing material atop the air path to prevent blockage caused by irrigation. It should be understood that wax-infiltrated carbon paper is not the exclusive sealing material that can or should be used; one can use other hydrophobic and gas-permeable sealing materials aside from wax-infiltrated carbon paper. As a non-limiting example, one can use PDMS film as a sealing material.

Aspect 12. The power cell of any one of Aspects 1-11, wherein the enclosure comprises at least one pore extending therethrough.

Aspect 13. The power cell of Aspect 12, further comprising a sealing material superposed over the at least one pore.

Aspect 14. The power cell of Aspect 13, wherein the sealing material comprises a wax.

Aspect 15. The power cell of Aspect 14, wherein the sealing material comprises a wax-infiltrated paper, the paper optionally comprising a carbon paper.

Aspect 16. The power cell of any one of Aspects 1-11, wherein the enclosure comprises at least one cavity extending partway through the enclosure.

Aspect 17. The power cell of any one of Aspects 1-16, wherein the power cell has a length, a width, or a thickness of less than about 10 mm. A cell can have dimensions of, for example, 20×20×7 mm, or even 10×8×5 mm.

Aspect 18. The power cell of any one of Aspects 1-18, wherein the power cell has a size profile of a kernel of corn.

Aspect 19. The power cell of any one of Aspects 1-18, wherein the power cell, in a soil environment, exhibits a peak power of up to about 10 mW cm^{31 2}. Peak power can, of course, be greater, for example up to about 15, 16, 17, 18, 19, 20 mW cm⁻² or even greater. Without being bound to any particular theory or embodiment, one can enlarge one or more air paths of the battery so as to meet the user's requirements.

Aspect 20. The power cell of any one of Aspects 1-19, wherein the power cell, in a soil environment, discharges at about 30 μA for up to about 180 days.

Aspect 21. The power cell of Aspect 20, wherein the power cell, in a soil environment, discharges at about 30 μA for up to about 50 days. Discharge can, however, be for longer periods of time, for example, up to 55, 60, or even 70 days or longer, for example up to 320 days, Aspect 22. The power cell of any one of Aspects 1-21, wherein the power cell, in a soil environment, exhibits a voltage discharge level that varies by less than about 20% for a period of 5 days.

Aspect 23. The power cell of any one of Aspects 1-22, wherein any one or more of the metallic anode, the air cathode, and the electrolyte are biodegradable. A biodegradable component can be one such that the environment in which the power cell is embedded causes any or more of the metallic anode, the air cathode, and the electrolyte to dissolve or otherwise degrade.

Aspect 24. A power cell, comprising: a metallic anode; an air cathode; an electrolyte, the electrolyte placing the metallic anode into electronic communication with the air cathode; and an enclosure, the enclosure encapsulating therein the metallic anode, the air cathode, and the electrolyte. The enclosure can define one or more air paths that admit air therein. The enclosure can preferentially permit passage of oxygen into the enclosure relative to passage of at least one of water and CO₂ into the enclosure. The enclosure can have at least one cross-sectional dimension of less than about 5 mm.

Aspect 25. The power cell of Aspect 24, wherein at least one of the metallic anode, the air cathode, the electrolyte, and the enclosure is biodegradable.

Aspect 26. A method, comprising implanting a power cell according to any one of Aspects 1-25 into a soil environment.

Aspect 27. A method, comprising assembling a power cell according to any one of Aspects 1-25.

Aspect 28. A method, comprising powering a device using a power cell according to any one of Aspects 1-25.

1. A power cell, comprising:
a metallic anode;
an air cathode;
an electrolyte, the electrolyte placing the metallic anode into electronic communication with the air cathode; and
an enclosure,
the enclosure encapsulating therein the metallic anode, the air cathode, and the electrolyte,
the enclosure defining an air path to admit air therein, the enclosure optionally preferentially permitting passage of oxygen into the enclosure relative to passage of at least one of water and CO₂ into the enclosure, and
the enclosure comprising a biodegradable material.

2. The power cell of claim 1, wherein the metallic anode comprises any one or more of Al, Fe, Mo, Mn, Mg, or Zn.

3. The power cell of claim 1, wherein the air cathode comprises a carbonaceous material, the carbonaceous material optionally comprising carbon paper.

4. (canceled)

5. The power cell of claim 1, wherein the enclosure comprises at least one of a wax and a biodegradable plastic.

6. The power cell of claim 5, wherein the wax comprises a natural wax or a naturally-derived wax, the wax optionally comprising beeswax, soy wax, or a wax derived from any one or more of beeswax, soy wax, candelilla wax, and myrtle wax.

7. (canceled)

8. (canceled)

9. The power cell of claim 1, wherein (a) the electrolyte has a neutral pH or an alkaline pH, (b) the electrolyte comprises a hydrogel, the hydrogel optionally comprising an additional polymer therein, or both (a) and (b).

10. (canceled)

11. The power cell of claim 1, wherein the enclosure is free of pores extending therethrough.

12. The power cell of claim 1, wherein the enclosure comprises at least one pore extending therethrough.

13. The power cell of claim 12, further comprising a sealing material superposed over the at least one pore, the sealing material optionally comprising a wax.

14. (canceled)

15. The power cell of claim 13, wherein the sealing material comprises a wax-infiltrated paper, the paper optionally comprising a carbon paper.

16. The power cell of claim 1, wherein the enclosure comprises at least one cavity extending partway through the enclosure.

17. The power cell of claim 1, wherein the power cell has a length, a width, or a thickness of less than about 10 mm.

18. The power cell of claim 1, wherein the power cell has a size profile of a kernel of corn.

19. The power cell of claim 1, wherein (a) the power cell, in a soil environment, exhibits a peak power of up to about 10 mW cm^{31 2}, (b) the power cell, in a soil environment, discharges at about 30 μA for up to about 180 days, or both (a) and (b).

20. (canceled)

21. (canceled)

22. The power cell of claim 1, wherein the power cell, in a soil environment, exhibits a voltage discharge level that varies by less than about 20% for a period of 5 days.

23. The power cell of claim 1, wherein any one or more of the metallic anode, the air cathode, and the electrolyte are biodegradable.

24. A power cell, comprising:
a metallic anode;
an air cathode;
an electrolyte, the electrolyte placing the metallic anode into electronic communication with the air cathode; and
an enclosure,
the enclosure encapsulating therein the metallic anode, the air cathode, and the electrolyte,
the enclosure defining an air path to admit air therein, the enclosure optionally preferentially permitting passage of oxygen into the enclosure relative to passage of at least one of water and CO₂ into the enclosure, and
the enclosure having at least one cross-sectional dimension of less than about 5 mm.

25. The power cell of claim 24, wherein at least one of the metallic anode, the air cathode, the electrolyte, and the enclosure is biodegradable.

26. A method, comprising implanting a power cell according to claim 1 into a soil environment.

27. (canceled)

28. A method, comprising powering a device using a power cell according to claim 1.
